(19) United States
(12) Patent Application Publication
(10) Pub. No.: US 2026/0072696 A1
(43) Pub. Date: Mar. 12, 2026

(54) Method for Operating a Segment of Cycle-Oriented Controller Software

(71) Applicant: Siemens Aktiengesellschaft, Muenchen (DE)

(72) Inventors: Maximilian WALTER, Nürnberg (DE); Jürgen BAUS, Eggenstein-Leopoldshafen (DE); Markus WALTER, Bamberg (DE); Ronny HOG, Kümmersbruck (DE); Julia SCHWEIGER, Hirschau (DE); Felix KRETSCHMER, Burgthann (DE); Sebastian SCHÖTZ, Hahnbach (DE)

(21) Appl. No.: 19/259,248

(22) Filed: Jul. 3, 2025

(30) Foreign Application Priority Data
Jul. 8, 2024 (EP) 24187091

(51) Int. Cl. G06F 9/4401

(52) U.S. Cl. CPC G06F 9/4401

(57) ABSTRACT

A method for operating a segment of cycle-oriented controller software for the fail-safe control of automation sequences of a process, wherein the controller software is executed within an IT infrastructure, where hardware properties and/or software properties are queried and checked as safety features to review the suitability of the IT infrastructure for performing the fail-safe automation sequences, and if the check is successful, then it can be inferred therefrom that the prerequisites for fail-safe operation are met, and thereupon the controller software obtains approval for regular operation, otherwise a safe state is adopted.

### BACKGROUND OF THE INVENTION

### 1. Field of the Invention

The invention relates to a method for operating a segment of cycle-oriented controller software for fail-safe control of automation sequences of a process, where the controller software is executed within an IT infrastructure.

### 2. Description of the Related Art

The invention relates to a method for operating a segment of cycle-oriented controller software for fail-safe control of automation sequences of a process, where the controller software is executed within an IT infrastructure.

Controllers that are common today are based on a hardware platform, a specific electronic substructure, i.e., a programmable logic controller (PLC). When speaking of virtual controllers or software controllers in recent times, hardware is also necessary for this for execution purposes, but the hardware now can be fully abstracted. This means that the executed Soft-PLC no longer needs to know the device upon which it is running.

These devices can be dedicated controller devices as before, such as multifunctional controller platforms or industrial PCs, or can be edge computing platforms, which increasingly can be found in controller networks of machine and installation operators, or even cloud-computing platforms are used. What is crucial is the abstraction of the hardware by containers and hypervisors. The Soft-PLC is “deployed” thereupon with standard means or is orchestrated using tools; an installation such as in the case of software-based control is no longer required.

The keyword hyperconverged infrastructure (HCI) refers to an IT infrastructure that is used to achieve a further degree of abstraction, which has an underlying software-centered architecture, in which processors, storage, network and virtualization and other technologies are closely interlinked with one another.

Hyperconverged infrastructure is a further development of converged infrastructure, in which hardware and software are also bundled. Conventional monolithic storage systems, such as Storage Area Network (SAN) or Network Attached Storage (NAS), which formed dedicated silos in the computing center, are being replaced by software-defined storage systems in hyperconverged infrastructure. The substantial components of a computing center thus migrate into one appliance and are managed by shared virtualization and management tools. The object of the storage software consists in providing the hard drives connected directly to the system (Direct Attached Storage (DAS)) or SSD media in the form of a virtual pool for the applications.

A hyperconverged infrastructure unifies computing power (processors and RAM) with mass storage (SSDs and hard drives) in each individual (virtual) machine, but connects the storage of multiple machines to storage software to form one unified system. This increases the performance and simplifies the management and automation under one unified administration interface. Improved fault tolerance can also be achieved. By and large, hyperconverged solutions have also been entrusted with the operation of business-critical applications in the meantime, such as running business processes, live applications and big data/analytics. HCI can also be used as a platform for virtual desktops in large companies, as well as in web hosting service providers.

The invention is in the specialist area of safety-oriented controllers, in particular in the form of software. According to the requirements of the standard EN 61508, programmable logic controllers must be established such that they meet a level of functional safety. In safety-related systems, such as programmable logic controllers for critical processes that contain electrical, electronic or programmable electronic components and the failure of which poses a significant risk to persons or the environment, they must be configured to guarantee a particular degree of safety. Examples of applications that require enhanced safety are the following: nuclear power stations, control technology for systems of significance in safety technology, rail applications, telecommunications technology, signaling technology and data processing systems, chemical processes, and also, for example, small installations, such as a punching machine for punching out sheet metal parts.

Classic functionally safe, programmable industrial controllers (for example, F-PLCs) are organized in layers. Executing on the lowest hardware layer are an operating system, a firmware and device drivers, with the applications executing on these.

A safe execution of the safety functions requires that the layers lying below have particular features (known as F-features). This includes, for example, a minimum level of hardware reliability (for example, mean time to failure of at least 2 years) and frequently a statement regarding the independence of components. If the safety concept is based on the redundant execution of the safety functions, for example, then it is frequently requested that the program must be executed on different CPU cores, in order to be able to identify permanent hardware errors. In addition, it can also be requested that other hardware components, such as (cache) storage, clock generators, primary and background memory for example, have to be separate.

These F-features are usually reviewed in the design phase, for example during the development of a new F-CPU. This requires the hardware architecture to already be known in the design phase.

In the context of what are known as software controllers, which consist only of software and are first assigned on commissioning of a particular segment of hardware, not all hardware properties are known during the design phase. The problem is exacerbated by hyperconverged infrastructure. This involves clusters of computing resources, upon which a large number of software controllers executed simultaneously, where the assignment of controller to computing resource can even change during ongoing operation.

A review of the F-features must occur in advance and generally in these cases, which in practice can be associated with great difficulties, and possibly even prevents the safety functions from being able to be implemented on an HCI at all. A further problem consists in a review of all F-features having to take place whenever a change is made to the HCI.

### SUMMARY OF THE INVENTION

It is an object of the invention to provide a method, with which a segment of cycle-oriented controller software for fail-safe control of automation sequences within an IT infrastructure can be operated in accordance with the conditions for fail-safe controllers.

This and other objects and advantages are achieved in accordance with the invention by a method in which in order to review the suitability of the IT infrastructure for performing the fail-safe automation sequences, hardware properties and/or software properties are queried and checked as safety features, and if the check is successful, then it can be inferred therefrom that the prerequisites for fail-safe operation are met, and thereupon the controller software obtains approval for regular operation, otherwise a safe state is adopted.

In accordance with the invention, the F-features, which the IT infrastructure must have, are checked automatically via software on commissioning or on each restart of the software controller or of the controller software. For example, in software F-CPUs, such a check could occur in a wake-up on-board unit or in the firmware.

The check then occurs fully automatically in a segment of software. If the check is successful, then it can be inferred therefrom that all F-features are met, and regular operation begins. Otherwise, not all F-features are considered to be met, and the system adopts a safe state. The safe state can, for example, consist in stopping all drives of the system or not starting them at all in the first place, and outputting a diagnostic message (e.g., display and/or warning light).

In a further embodiment of the method, a querying occurs, cyclically during regular operation, to determine whether a repeat review is required due to changes in the infrastructure, and in the event that a change has come about, the regular operation is initially maintained and, in parallel, the hardware properties and/or software properties are queried as safety features.

The tests of the F-features could be implemented at regular intervals (for example, every 10 minutes) during the operation. This is necessary if the software controller or the controller software are to be shifted between different systems during ongoing operation (for example, migration due to load balancing). Here, it is insufficient to check the F-features once at the start. Alternatively, the F-features can also be checked in an event-based manner, as soon as a migration has occurred.

As an alternative to cyclical checking, a repeat review can also be initiated in an event-controlled manner during regular operation due to a change event; the regular operation is initially maintained and, in parallel, the hardware properties and/or software properties are queried as safety features.

Advantageously, the presence of independent and diversely configured data storage units as a hardware property for a first safety feature is queried, for which purpose a storage region is reserved in a first data storage unit and a storage region is also reserved in a second data storage unit, where a number of storage accesses to the reserved storage regions are now performed in an alternating manner, if the temporal access values to both storage regions are almost identical then it is inferred that the first storage unit and second storage unit are not configured in an independent and diverse manner, from which it follows that the check was not successful.

As different (diverse) storage units have different runtime behavior, this can be reviewed by a microbenchmark (for example, N accesses to random addresses of the storage in each case). If N is large, then the performance values are approximately equal if storage units are identical, but they differ greatly if storage units are different (for example, DRAM and solid state drive).

With one method, the presence of independent and diversely configured data storage units can be proven as follows: a first timestamp is detected and then, repeated according to the number, a read operation is performed on the first storage unit and a write operation is performed on the first storage unit. Once the repeated writing and reading have finished, a second timestamp is detected and subsequently, repeated according to the number, a read operation is performed on the second storage unit and a write operation is performed on the second storage unit. Once the repeated writing and reading have finished, a third timestamp is detected, a first total access time is calculated from the difference between the second timestamp and the first timestamp and a second total access time is calculated from the difference between the third timestamp and the second timestamp. A check is then performed to determine whether a further difference between the first total access time and the second total access time exceeds a specifiable deviation, and if this is the case then the first safety feature is met.

With a further method step, it is possible to prove the presence of independent storage units which nonetheless are structurally identical as a hardware property for a second safety feature, as follows: to this end, a storage region is reserved in a first data storage unit and a storage region is also reserved in a second data storage unit. Now, in a first test phase, a number of storage accesses to the reserved storage regions of the first storage unit are performed at a repetition rate. In a second test phase, a number of storage accesses to the reserved storage regions of the first storage are then performed in turn at a repetition rate, but now an additional number of additional storage accesses to the reserved storage regions of the second storage unit are additionally performed. If the temporal access values of the storage accesses to the reserved storage regions of the first data storage unit in the first test phase and in the second test phase are approximately equal, then it is inferred that the first data storage unit and the second data storage unit are independent of one another, because otherwise a shared cache of the data storage units would have influenced the time behavior.

The presence of a first clock and a second clock, which are based on a first clock generator and a second clock generator, where the clock generators must operate independently of one another as a hardware property and thus for a third safety feature, can be checked as follows: in each case, a first clock timestamp of the first clock and the second clock is detected in each case, after which one of the following checking methods is performed: a waiting time is started in a first checking method, the running behavior of the first clock is altered in a targeted manner in a second checking method and the IT infrastructure is restarted in a third checking method. After this a second clock timestamp of the first clock and the second clock is detected in each case, a first clock time difference and a second clock time difference are formed from the second clock timestamps and the first clock timestamps. A check is subsequently performed to determined whether a difference between the first clock time difference and the second clock time difference exceeds a specifiable deviation, and if this is the case then the third safety feature is met.

The independence of clock generators can be demonstrated by the clocks realized thereby being run for a certain time. If both clocks are realized internally with the aid of the same clock generator, then these always indicate the same clock time. If both clocks are realized by different generators, then a small deviation occurs after a certain time.

A further option, which requires less time, consists in falsifying one of the two clocks in a targeted manner, for example, via a targeted change to the clock running of one of the clock generators. This change is only permitted to affect one of the two clocks. If this is the case, then independent clock generators can be assumed, and the change to the clock running can be rolled back. Otherwise, it was identified that the clock generators are not independent of one another.

In many cases, one of the clock generators is dependent upon the network voltage, while the other continues to run with the aid of a battery even without network voltage. Here, the independence of the clock can be checked by restarting the system: if both clocks then indicate a different clock time, then one clock has continued to run during the restart, while the other has not. The clocks therefore have independent clock generators.

If the safety concept is based on the redundant execution of the safety functions, for example, then it is frequently requested that the program must be executed on different CPU cores, in order to be able to identify permanent hardware errors. In addition, it can also be requested that other hardware components, such as (cache) storage, clock generators, primary and background storage, must be separate.

If a first runtime environment and a second runtime environment are made available to the controller software in the IT infrastructure, as a fourth safety feature, a check is then performed to determine whether the runtime environments are realized independently of one another, for which a first process is started in the first runtime environment and a second process is started in the second runtime environment, where additional computing actions are executed in the second runtime environment to strain the second runtime environment, and a check is then performed to determine whether the processes have execution durations with different lengths.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows one exemplary embodiment of the invention, in which:

FIG. 1 shows a flow diagram for querying safety features in accordance with the invention;

FIG. 2 shows a flow diagram for querying whether a change in the infrastructure has been performed in accordance with the invention;

FIG. 3 shows a flow diagram for querying whether two storage units are not structurally identical and diverse in accordance with the invention;

FIG. 4 shows a flow diagram for querying of whether two storage units are indeed structurally identical, but nonetheless are independent of one another in accordance with the invention;

FIG. 5 shows a flow diagram for querying whether two clocks that are independent of one another are present in accordance with the invention;

FIG. 6 shows a flow diagram for the querying of whether two runtime environments that are independent of one another are present in the IT infrastructure in accordance with the invention; and

FIG. 7 shows an overview image of an IT infrastructure in accordance with the invention.

### DETAILED DESCRIPTION OF THE EXEMPLARY EMBODIMENTS

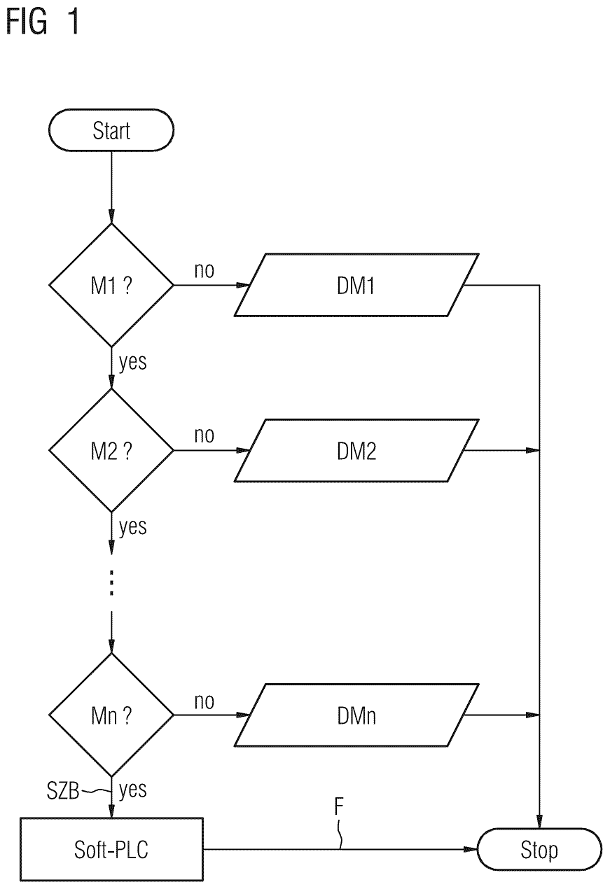

FIGS. 1 to 6 present flow diagrams, with which it is shown how F-features in software can be checked automatically during commissioning or on each restart of a software controller Soft-PLC. This is particularly important if the controller software Soft-PLC is executing on an IT infrastructure 1, in particular on a hyperconverged infrastructure HCI.

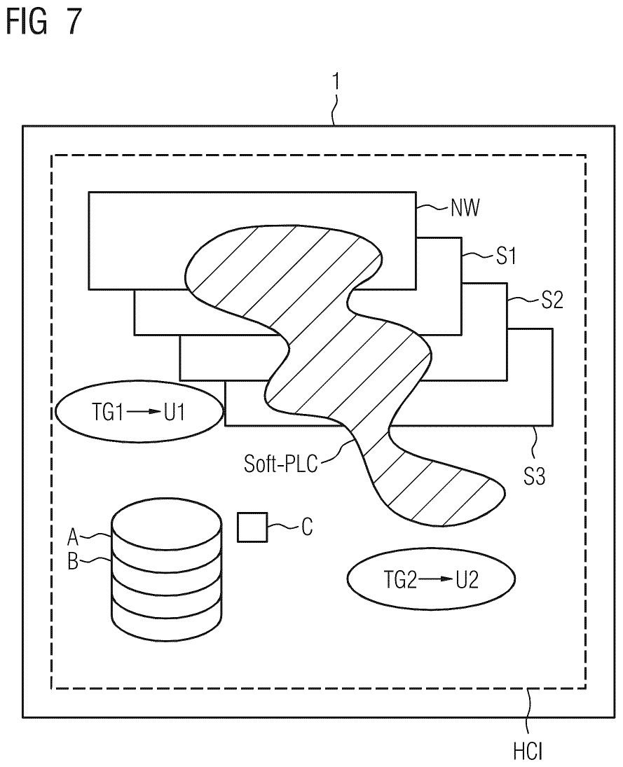

FIG. 7 shows an IT infrastructure 1, in particular the hyperconverged infrastructure HCI. In a hyperconverged infrastructure HCI, a server, computer and virtual machines are storage and network solutions can be controlled in an integrated and central manner. In the context “software controllers”, i.e., the controller software Soft-PLC, it is important for fail-safe execution to query F-features. These F-features are queried as safety features M1, . . . , Mn. This makes it possible to ensure that safety functions, F-features and/or the safety features M1, . . . , Mn can also be executed or are present on a hyperconverged infrastructure HCI.

The flow diagram in of FIG. 1 is used in a method for operating a segment of cycle-oriented controller software Soft-PLC in order to ensure proof of a fail-safe controller for the controller software Soft-PLC, which is executed within the IT infrastructure 1.

In order to review the suitability of the IT infrastructure 1 for performing the fail-safe automation sequences, hardware properties and/or software properties are queried as the safety features M1, . . . , Mn. After starting the method, a first safety feature M1 is queried. If the safety feature is not met, then a first diagnostic message DM1 is issued, and the system stops and enters a safe state. If the first safety feature M1 is met, then a second safety feature M2 is queried. If the second safety feature M2 is not met, then a second diagnostic message DM2 is issued, and the system enters a safe state. The querying of the safety features M1, . . . , Mn continues in the manner of a chain, until a last n-th safety feature Mn. If the last n-th safety feature Mn is met, then an approval SZB (safe cyclical operation) is granted and the safe, cyclical operation of the controller software Soft-PLC can start. Should an error F occur during the safe cyclical operation of the controller software Soft-PLC, then this error F is signaled and the system enters a safe stop state.

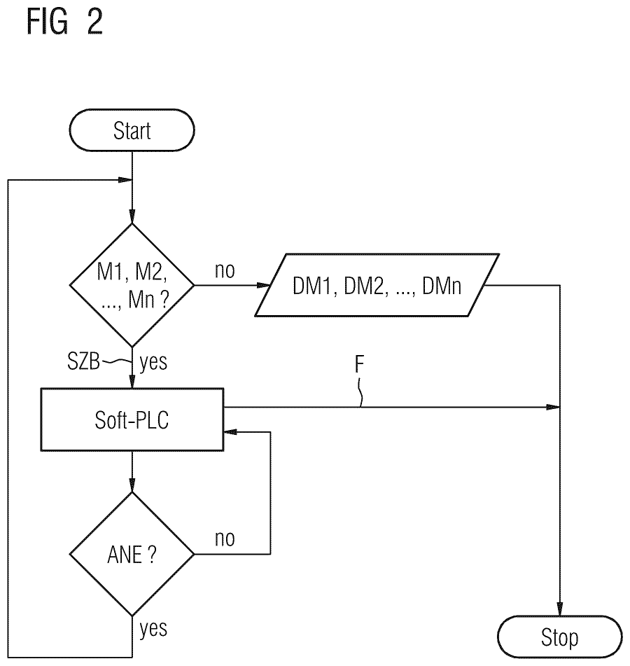

An additional query in the method is presented by FIG. 2. After the start, the already-queried safety features M1,M2, . . . , Mn are queried again. If all safety features M1, . . . , Mn are met, then the approval SZB is granted. Should a safety feature not be met during the querying, then the corresponding diagnostic message DM1,DM2, . . . , DMn is issued and the system enters a stop state or a safe state. With the approval SZB, the controller software Soft-PLC now operates in a safe cyclical operation on the IT infrastructure 1.

It is now advantageous if querying occurs, cyclically during regular operation, as to whether a repeat review is required due to changes in the IT infrastructure 1, and in the event that a change has come about, the regular operation is initially maintained and, in parallel, the hardware properties and/or software properties are queried as safety features M1, . . . , Mn again. This is always necessary if the software controller or the controller software Soft-PLC are to be shifted between different systems during ongoing operation of the IT infrastructure 1 (for example, migration due to load balancing). In that case, it is certainly no longer sufficient to check the F-features once at the start. During regular operation of the controller software Soft-PLC, it is likewise possible to initiate an event-controlled repeat review due to a change event.

In further advantageous embodiment, during the review, the system does not transition into a safe state immediately if it has found a safety feature M1, . . . , Mn which is not met, but rather, as part of the diagnostics, the system announces the cause of the violation and possibly offers support as to how this cause can be rectified. The following support would then be able to be read in the first diagnostic message DM1, for example: “It has been detected that a first data storage unit B and a second data storage unit A are not designed independently of one another and in a diverse manner”.

After starting the safe cyclical operation via the approval SZB, a check regarding the safety features M1, . . . , Mn is performed again by way of a query for reassessment ANE, for example every ten minutes.

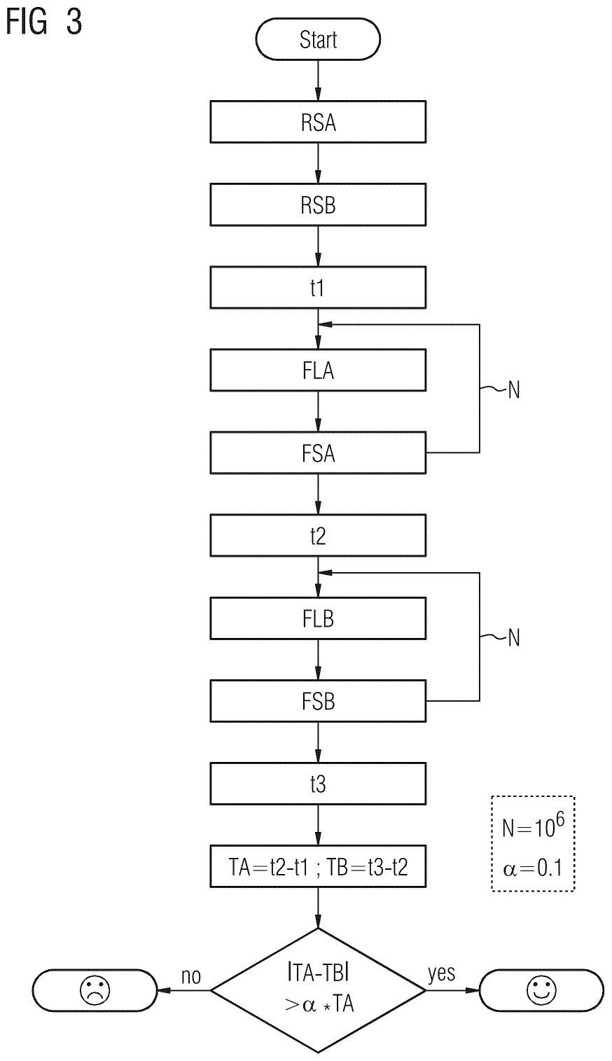

The flow diagram of FIG. 3 shows a querying of whether two storage units are configured such that they are not structurally identical and diverse. To this end, after starting, a first method step RSA is performed, in which storage is reserved in a first data storage unit A. Subsequently, a second method step RSB is performed, in which storage is reserved in a second data storage unit B. A first timestamp t1 is detected, then in a further method step FLA, in accordance with a number N, a read operation is performed on the first data storage unit A and a write operation is performed on the first data storage unit A. The read operation on the first data storage unit A is performed in a method step FLA and the write operation on the first data storage unit A is performed in a method step FSA. After N repetitions, a second timestamp t2 is detected. Now, in turn, repeated in accordance with the number N, a read operation is performed on the second data storage unit B and a write operation is performed on the second data storage unit B. The read operation on the second data storage unit B is performed in a method step FLB and the write operation on the second data storage unit B is performed in a method step FSB. Once the repeated writing and reading have finished, a third timestamp t3 is detected.

In the next method step, a first total access time TA is calculated from the difference between the second timestamp t2 and the first timestamp t1. A second total access time TB is also calculated from the difference between the third timestamp t3 and the second timestamp t2. A check is then performed to determine whether a further difference between the first total access time TA and the second total access time TB exceeds a specifiable deviation, and if this is the case then the first safety feature M1 is met. The specifiable deviation is given, for example, by a factor α, which could be 10⁻⁶, multiplied by the product of the first total access time TA. As different (diverse) storage units have different runtime behavior, this can be reviewed by the previous microbenchmark for random addresses of the data storage units A, B. In the case of a large number N, then the performance values are approximately equal if storage units are identical, but the performance values differ greatly if storage units are different, for example, D-RAM and solid state drive.

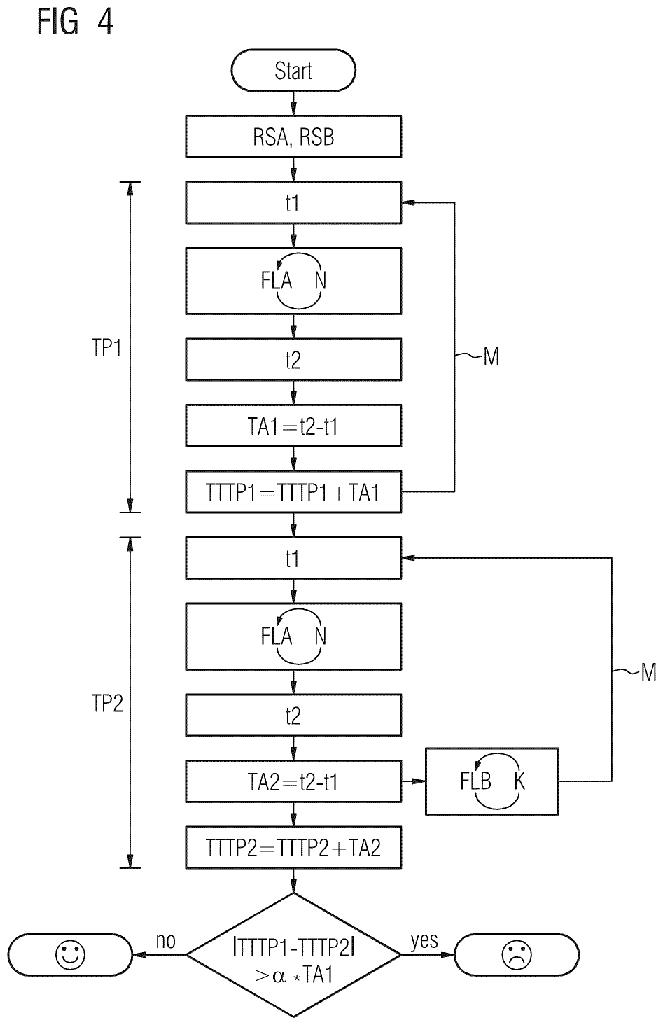

FIG. 4 presents a flow diagram for the querying of whether two storage units are indeed structurally identical, but nonetheless are independent of one another. Initially, again in a first method step RSA and in a second method step RSB, a storage region is reserved in the first data storage unit A and a storage region is also reserved in the second data storage unit B. Now, in a first test phase TP1, a number N of storage accesses to the reserved storage regions of the first storage unit A are performed at a repetition rate M. During the cycle of the repetition rate M, a first timestamp t1 is recorded repeatedly and the method step FLA is performed N times, with a second timestamp t2 then being detected. In the first test phase TP1, the difference between the second timestamp t2 and the first timestamp t1 is formed repeatedly as a first differentiating time TA1. Furthermore, a first total access time TTTP1 is formed in the first test phase TP1 (T—total in the first test phase TP1).

In a second test phase TP2, again, a first timestamp t1 is then ascertained and, again, a number N of storage accesses to the reserved storage regions of the first storage unit A are performed at the repetition rate M, but now an additional number K of additional storage accesses to the reserved storage regions of the second storage unit B are additionally performed. After detecting the first timestamp t1, in the method step FLA, N read operations are again executed on the first data storage unit A, then the second timestamp t2 is detected and, again, the second time difference TA2 between the second timestamp t2 and the first timestamp t1 is formed, and a further second total access time TTP2 is formed by adding up the respective second time difference to form the second total access time TTTP2 (t—total in second test phase TP2). If the N repetitions have been worked through, then a check is performed to determine whether the access values of the storage accesses to the first reserved storage regions of the first data storage unit A are approximately identical in the first test phase TP1 and in the second test phase TP2. If this is the case, then it is inferred that the first data storage unit A and the second data storage unit B are independent of one another, because otherwise a shared cache C of the data storage units A, B would have influenced the time behavior. If the result is positive in the case of comparing the temporal access values, then the second safety feature M2 is not met, because the storage units are not independent of one another. If the result is negative, then this is a sign that the storage units are independent of one another, i.e., two physically separate storage units are present.

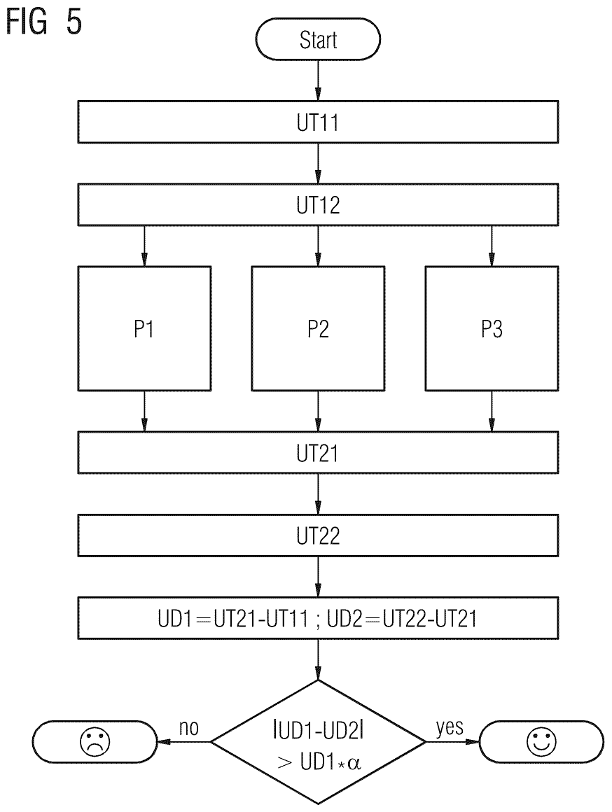

According to FIG. 5, a flow diagram is presented for checking a third safety feature M3. To this end, the presence of a first clock U1 and a second clock U2, which are based on a first clock generator TG1 and a second clock generator TG2, is queried after starting. The clock generators TG1,TG2 should have to operate as a hardware property and thus independently of one another for the third safety feature M3.

After starting, a first clock timestamp UT11,UT12 of the first clock U1 and the second clock U2 is detected in each case. In the flow diagram of FIG. 5, it is possible to run through three alternative checking methods P1,P2,P3. A waiting time WZ is started in a first checking method P1, the running behavior of the first clock U1 is altered in a targeted manner in a second checking method P2 and the IT infrastructure 1 is restarted in a third checking method P3.

The waiting time WZ started in the first checking method P1 could be one hour, for example. In the second checking method P2, the running accuracy is specified by a variable frequency of the clock generator, and additionally it is possible to wait 1 minute. The third checking method P3 is self-explanatory due to the reboot of the system. What all three checking methods P1,P2,P3 have in common is that a second timestamp UT21 of the first clock U1 is detected afterward. A second timestamp UT22 of the second clock U2 is detected almost simultaneously. In a following method step, a first clock time difference UT1 and a second clock time difference UT2 are formed. The clock time differences UT1,UT2 are each produced from the second timestamp minus the first timestamp UT21 of the first clock U1 or from the second timestamp UT22 minus the first timestamp UT21 of the second clock U2. A check is then performed to determined whether a difference between the first clock time difference UT1 and the second clock time difference UT2 exceeds a specifiable deviation, and if this is the case then the third safety feature M3 is met.

The flow diagram of FIG. 5 follows the principle that the independence of clock generators TG1,TG2 can be demonstrated by the clocks U1,U2 realized thereby being run for a certain time. If both clocks U1,U2 are realized internally with the same clock generators or the same clock generator, then these always indicate the same clock time. If both clocks U1,U2 are realized by different clock generators TG1,TG2, then a small deviation occurs after a certain time.

Particularly in the second checking method P2, the test consists in falsifying one of the two clocks U1,U2 in a targeted manner, for example, via targeted changes to the clock running of one of the clock generators TG1,TG2. This change is only permitted to affect one of the two clocks U1,U2. If this is the case, then independent clock generators TG1,TG2 can be assumed, and the change to the clock running can be rolled back.

Otherwise, it was identified that the clock generators TG1,TG2 are not independent of one another.

In many cases, one of the clock generators is dependent upon a network voltage, while the other clock generator continues to run even without network voltage and with the aid of a battery. Here, the independence of the clock can be checked by restarting the system. If both clocks then indicate a different clock time, then one clock has continued to run during the restart, while the other clock has not. The clocks therefore have independent clock generators.

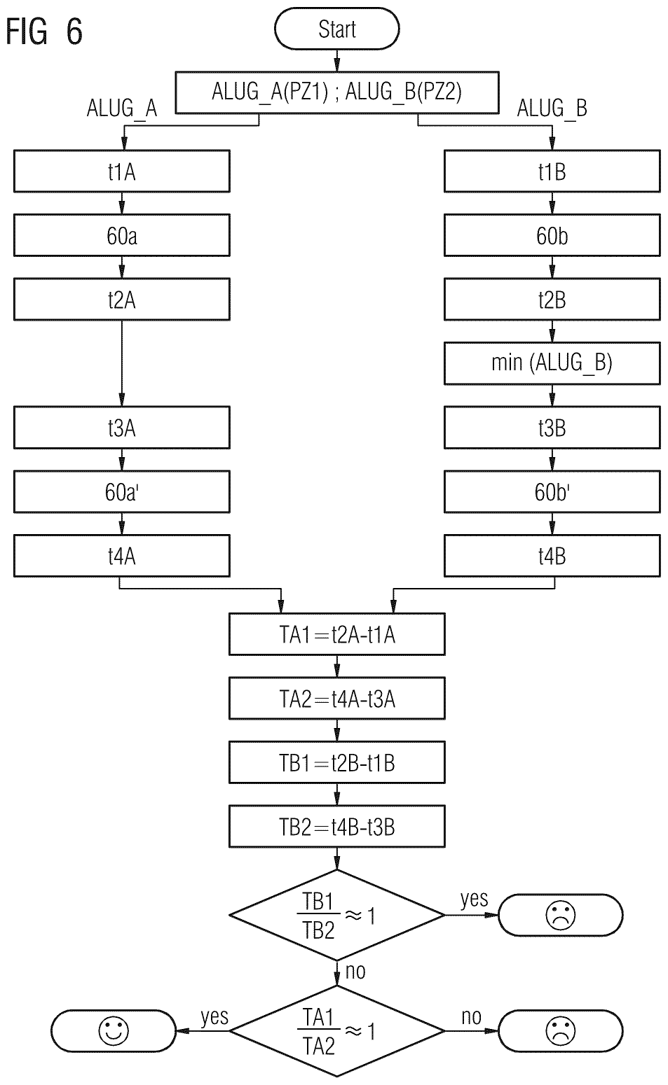

With reference to FIG. 6, a flow diagram is illustrated for checking whether two processes PZ1,PZ2 are running on different computers or on different runtime levels ALUG_A, ALUG_B. To this end, a first runtime environment ALUG_A and a second runtime environment ALUG_B are made available in the IT infrastructure 1 for the controller software Soft-PLC. The first process PZ1 is started in the first runtime environment ALUG_A and the second process PZ2 is started in the second runtime environment ALUG_B. A first timestamp t1A is detected in the first runtime environment ALUG_A. Subsequently, in a method step 60a, the computer is burdened due to performing calculations with constant effort, after which a second timestamp t2a is detected. In parallel, a first timestamp t1b is detected in the second runtime environment ALUG_B, and calculations with constant effort are again performed in a method step 60b. After this, a second timestamp t2b is detected, but now the computing power is throttled in the second runtime environment ALUG_B. A third timestamp t3a is detected in the first runtime environment ALUG_A and calculations with constant effort are again performed in a method step 60a′. After this, a fourth timestamp t4a is detected. Also in parallel, a third timestamp t3b is detected in the second runtime environment ALUG_B after the throttling of the computing speed of the second runtime environment ALUG_B, and subsequently calculations with constant effort are again carried out in a method step 60b. After this, a fourth timestamp t4b is detected. The detected timestamp of the first runtime environment ALUG_A and ALUG_B are now evaluated as follows. For the first runtime environment ALUG_A, a first difference time TA1 and a second difference time TA2 are formed from the detected timestamps and, for the second runtime environment ALUG_B, a first difference time TB1 and a second difference time DB2 are formed from the detected timestamps A check is now performed to determine whether the ratio of the first difference time TB1 to the second difference time TB2 of the second runtime environment ALUG_B is approximately 1. If this is the case, then the test has failed, which means that the throttling has not shown any effect. If the ratio of the first difference time TB1 to the second difference time TB2 is not approximately 1, then there is a further query. Here, a check is performed to determine whether the ratio of the first difference time TA1 to the second difference time TA2 of the first runtime environment ALUG_A is approximately 1. If this is the case, then the test has been successful. This means that the computers A and B, or the first runtime environment ALUG_A and the second runtime environment ALUG_B are independent of one another.

As already explained further above, FIG. 7 is discussed again, which maps an IT infrastructure 1 that is configured as a hyperconverged infrastructure HCI. A first server S1, a second server S2 and a third server S3 are present. A first data storage unit A and a second data storage unit B are likewise present. Furthermore, a cache C is present. A first independent clock generator TG1 sees to the presence of a first clock U1. A second clock generator TG2 sees to the presence of a second clock U2. A network NW is present. The cycle-oriented controller software Soft-PLC for the fail-safe control of automation sequences is now distributed in the hypercontingent infrastructure HCI as a segment of executable software.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a segment of cycle-oriented controller software for fail-safe control of automation sequences of a process, the cycle-oriented controller software being executed within an IT infrastructure, the method comprising:
querying and checking at least one of hardware properties and software properties are queried and checked as safety features to review suitability of an IT infrastructure for performing the fail-safe automation sequences; and
inferring from the querying and checking that prerequisites for fail-safe operation are met, if the check is successful, then it can be inferred therefrom that the prerequisites for fail-safe operation are met; and
providing the controller software with approval for regular operation, otherwise adopting a safe state if the check is unsuccessful.

2. The method as claimed in claim 1, wherein querying occurs, cyclically during regular operation, as to whether a repeat review is required due to changes in the infrastructure, and in an event that a change has occurred, regular operation is initially maintained and, in parallel, at least one of the hardware properties and the software properties are queried as the safety features.

3. The method as claimed in claim 1, wherein a repeat review is initiated in an event-controlled manner during regular operation due to a change event, the regular operation is initially maintained and, in parallel, at least one of the hardware properties and the software properties are queried as the safety features.

4. The method as claimed in claim 1, wherein a presence of independent and diversely configured data storage units is queried as a hardware property for a first safety feature, a storage region being reserved in a first data storage unit and a storage region being also reserved in a second data storage unit, and a number of storage accesses to the reserved storage regions being now performed in an alternating manner, if temporal access values to both storage regions are almost identical then an inference is established indicating that the first data storage unit and second data storage unit are not configured in an independent and diverse manner, which indicates the check was unsuccessful.

5. The method as claimed in claim 2, wherein a presence of independent and diversely configured data storage units is queried as a hardware property for a first safety feature, a storage region being reserved in a first data storage unit and a storage region being also reserved in a second data storage unit, and a number of storage accesses to the reserved storage regions being now performed in an alternating manner, if temporal access values to both storage regions are almost identical then an inference is established indicating that the first data storage unit and second data storage unit are not configured in an independent and diverse manner, which indicates the check was unsuccessful.

6. The method as claimed in claim 3, wherein a presence of independent and diversely configured data storage units is queried as a hardware property for a first safety feature, a storage region being reserved in a first data storage unit and a storage region being also reserved in a second data storage unit, and a number of storage accesses to the reserved storage regions being now performed in an alternating manner, if temporal access values to both storage regions are almost identical then an inference is established indicating that the first data storage unit and second data storage unit are not configured in an independent and diverse manner, which indicates the check was unsuccessful.

7. The method as claimed in claim 4, further comprising:
detecting a first timestamp, and repeating said detecting in accordance with a number;
performing a read operation on the first data storage unit and performing a write operation on the first data storage unit;
detecting a second timestamp and subsequently repeating said detecting of the second timestamp in accordance with the number, once the repeated writing and reading have finished;
performing a read operation on the second data storage unit and performing a write operation on the second data storage unit;
detecting a third timestamp once the repeated writing and reading have finished;
calculating a first total access time from a difference between the second timestamp and the first timestamp and calculating a second total access time from a difference between the third timestamp and the second timestamp; and
performing a check to determine whether a further difference between the first total access time and the second total access time exceeds a specifiable deviation, the first safety feature being established as met if the further difference between the first total access time and the second total access time exceeds the specifiable deviation.

8. The method as claimed in claim 1, further comprising:
performing a query as a hardware property for a second safety feature to determined a presence of independent storage units which nonetheless are structurally identical is queried, a storage region being reserved in a first data storage unit and a storage region being also reserved in a second data storage unit;
performing, in a first test phase, a number of storage accesses to the reserved storage regions of the first data storage unit at a repetition rate;
performing, in a second test phase, the number of storage accesses to the reserved storage regions of the first data storage unit at the repetition rate, an additional number of additional storage accesses to the reserved storage regions of the second data storage unit being additionally performed; and
inferring that the first data storage unit and the second data storage unit are independent of one another, based on a shared cache of the data storage units having no influence on a time behavior, if the temporal access values of the storage accesses to the reserved storage regions of the first data storage unit in the first test phase and in the second test phase are approximately equal.

9. The method as claimed in claim 2, further comprising:
performing a query as a hardware property for a second safety feature to determined a presence of independent storage units which are structurally identical is queried, a storage region being reserved in a first data storage unit and a storage region being also reserved in a second data storage unit;
performing, in a first test phase, a number of storage accesses to the reserved storage regions of the first data storage unit at a repetition rate;
performing, in a second test phase, the number of storage accesses to the reserved storage regions of the first data storage unit at the repetition rate, an additional number of additional storage accesses to the reserved storage regions of the second data storage unit being additionally performed; and
inferring that the first data storage unit and the second data storage unit are independent of one another, based on a shared cache of the data storage units having no influence on a time behavior, if the temporal access values of the storage accesses to the reserved storage regions of the first data storage unit in the first test phase and in the second test phase are approximately equal.

10. The method as claimed in claim 3, further comprising:
performing a query as a hardware property for a second safety feature to determined a presence of independent storage units which are structurally identical is queried, a storage region being reserved in a first data storage unit and a storage region being also reserved in a second data storage unit;
performing, in a first test phase, a number of storage accesses to the reserved storage regions of the first data storage unit at a repetition rate;
performing, in a second test phase, the number of storage accesses to the reserved storage regions of the first data storage unit at the repetition rate, an additional number of additional storage accesses to the reserved storage regions of the second data storage unit being additionally performed; and
inferring that the first data storage unit and the second data storage unit are independent of one another, based on a shared cache of the data storage units having no influence on a time behavior, if the temporal access values of the storage accesses to the reserved storage regions of the first data storage unit in the first test phase and in the second test phase are approximately equal.

11. The method as claimed in claim 1, further comprising:
performing a query to determine presence of a first clock and a second clock, which are based on a first clock generator and a second clock generator;
wherein the clock generators must operate independently of one another as a hardware property and to provide a third safety feature, a first clock timestamp (UT11,UT12) of the first clock (U1) and the second clock (U2) each being detected, after which one of the following checking methods is performed:
starting a waiting time in a first checking method;
altering a running behavior of the first clock in a targeted manner in a second checking method;
restarting the IT infrastructure in a third checking method;
detecting subsequently a second clock timestamp of the first clock and the second clock;
forming a first clock time difference and a second clock time difference formed from the second clock timestamps and the first clock timestamps; and
performing a check to determine whether a difference between the first clock time difference and the second clock time difference exceeds a specifiable deviation, the third safety feature being met is met if the difference between the first clock time difference and the second clock time difference exceeds the specifiable deviation.

12. The method as claimed in claim 1, wherein a first runtime environment and a second runtime environment are made available to the controller software in the IT infrastructure;
wherein, as a fourth safety feature, a check is performed to determine whether the runtime environments are realized independently of one another, a first process being started in the first runtime environment and a second process being started in the second runtime environment; and
wherein additional computing actions are executed in the second runtime environment to strain the second runtime environment, and a check is subsequently performed to determine whether the processes have execution durations with different lengths.
